(19) United States
(12) Patent Application Publication
(10) Pub. No.: US 2026/0070035 A1
(43) Pub. Date: Mar. 12, 2026

(54) PHOSPHORUS ADSORBENT AND PREPARATION METHOD THEREOF

(71) Applicant: Tongji University, Shanghai (CN)

(72) Inventors: Yunhui ZHANG, Shanghai (CN); Zhenhua DUAN, Shanghai (CN); Bin DONG, Shanghai (CN); Yuhao WANG, Shanghai (CN); Minjie HOU, Shanghai (CN); Zuxin XU, Shanghai (CN)

(21) Appl. No.: 19/172,940

(22) Filed: Apr. 8, 2025

(30) Foreign Application Priority Data
Sep. 12, 2024 (CN) 202411274304.7

(51) Int. Cl. B01J 20/04; B01J 20/30

(52) U.S. Cl. CPC B01J 20/048; B01J 20/3021; B01J 20/3078; B01J 2220/4806

(57) ABSTRACT

A method for preparing a phosphorus adsorbent, including: drying a waste gypsum to remove moisture; crushing and sieving an obtained dried gypsum to obtain a crushed gypsum; subjecting the crushed gypsum to pyrolysis in an inert gas atmosphere to obtain a pyrolysis product; and grinding and sieving the pyrolysis product to obtain the phosphorus adsorbent; wherein based on a total weight of the waste gypsum, the waste gypsum includes less than 47 wt % of SO₃, more than 45 wt % of CaO, and less than 1 wt % of Al₂O₃. Also provided is a phosphorus adsorbent prepared by the method.

### CROSS REFERENCE TO RELATED APPLICATION

This patent application claims the benefit and priority of Chinese Patent Application No. 202411274304.7 filed with the China National Intellectual Property Administration on Sep. 12, 2024, the disclosure of which is incorporated by reference herein in its entirety as part of the present application.

### TECHNICAL FIELD

The present disclosure relates to the technical field of water pollution control, and in particular relates to a phosphorus adsorbent and a preparation method thereof.

### BACKGROUND

Phosphorus is one of the essential elements for life and plays an important role in organisms. The phosphorus is essential for the growth, metabolism, and energy conversion of the organisms as a component of biological molecules such as DNA, RNA, and ATP. In the agricultural field, the phosphorus is one of the essential nutrients for plant growth. Supply of the phosphorus in fertilizers could increase a yield and a quality of crops. However, excessive release of the phosphorus into water bodies could lead to eutrophication, triggering a series of environmental problems including excessive algal growth, algal blooms, eutrophication of water bodies, and ecosystem collapse. The eutrophication not only affects the ecological balance of the water bodies and sustainable use of water resources, but may also have a negative impact on human health and well-being. Therefore, it is crucial to control and recycle the phosphorus in the water bodies.

Gypsum board is a material made of construction gypsum as a main raw material, with calcium sulfate dihydrate as a main component. The gypsum board is widely used in construction and decoration due to its light weight, easy processing, sound insulation, heat insulation, and flame retardancy and other characteristics. With continuous investment and construction of gypsum industry projects, an output of waste gypsum boards is also accumulating and has become an environmental problem to be addressed urgently. Traditional methods of treating gypsum board waste mainly include landfilling, incineration, and recycling. However, these methods show some significant disadvantages. The landfilling of the gypsum boards could cause a waste of resources and may lead to soil and groundwater pollution. The incineration may release harmful gases to cause air pollution. The recycling is restricted by technical limitations and economic costs. Accordingly, there is an urgent need to treat and dispose of the gypsum board waste in a more energy-saving and environmentally-friendly way to minimize impact on environment and to realize resource utilization of the gypsum board waste.

Pyrolysis refers to a process of decomposing compounds into simpler compounds or elements by heating in an anoxic environment and is a common method for preparing adsorbents. Moisture or other impurities on a surface of waste gypsum materials may occupy active sites and affect their adsorption capacity for target molecules. These surface impurities are removed by the pyrolysis, thereby releasing the active sites to improve the adsorption capacity of the adsorbent. The traditional pyrolysis is generally conducted at a high temperatures of 300° C. to 800° C., which triggers chemical reactions and structural changes within the material. Organic substances could decompose to produce gases, while inorganic substances may partially pyrolyze, dehydrate, or transform into other compounds within this temperature range. In addition, high-temperature pyrolysis may also lead to increased crystallinity and changes in a pore structure of a material, thus affecting physical and chemical properties of the material. However, the high-temperature pyrolysis shows great energy consumption, many side reactions, and high requirements for equipment, thereby resulting in increased product preparation costs.

As a result, it is necessary to develop a low-temperature pyrolysis process for the waste gypsum materials and thereby obtain a material with higher phosphorus adsorption performance to overcome problems in the prior art.

### SUMMARY

In order to solve the above problems, the present disclosure provides a method for preparing a phosphorus adsorbent using a waste construction gypsum as a raw material. The method achieves resource utilization of waste gypsum boards and could recover phosphorus in water, and is in line with the concept of “waste control by waste”. In this way, harms due to secondary release of calcium sulfate and other ions by the waste gypsum boards in the natural environment are avoided.

The present disclosure provides a method for preparing a phosphorus adsorbent, including:
S1, drying a waste gypsum to remove moisture;
S2, crushing and sieving an obtained dried gypsum to obtain a crushed gypsum;
S3, subjecting the crushed gypsum to low-temperature pyrolysis to obtain a pyrolysis product; and
S4, grinding and sieving the pyrolysis product to obtain the phosphorus adsorbent;
where based on a total weight of the waste gypsum, the waste gypsum includes less than 47 wt % of SO₃, more than 45 wt % of CaO, and less than 1 wt % of Al₂O₃.

In some embodiments, the waste gypsum is a construction waste gypsum.

In some embodiments, the drying is conducted at a temperature of 100° C. to 120° C. for 24 hours. In some embodiments, the drying is conducted at 105° C.

In some embodiments, the low-temperature pyrolysis is conducted in an anaerobic environment or an anoxic environment.

In some embodiments, the low-temperature pyrolysis is conducted under an inert gas atmosphere.

In some embodiments, an inert gas in the inert gas atmosphere includes but is not limited to nitrogen and argon.

In some embodiments, the inert gas has a flow rate of 0.5 L/minute to 2 L/minute.

In some embodiments, the low-temperature pyrolysis is conducted at a pyrolysis temperature of 150° C. to 300° C. for 1 hour to 4 hours, and the pyrolysis temperature is obtained by heating at a heating rate of 5° C./minute to 10° C./minute. In some embodiments, the low-temperature pyrolysis is conducted at the pyrolysis temperature of 150° C. for 2 hours.

The present disclosure further provides a phosphorus adsorbent prepared by the method.

Compared with the prior art, some embodiments of the present disclosure have the following beneficial technical effects.

In the present disclosure, pyrolysis is conducted at a low temperature to convert a gypsum board into a material with higher adsorption performance, providing a new solution to phosphorus pollution in water bodies.

In the present disclosure, low-temperature pyrolysis shows reduced energy consumption and low requirements for equipment. Moreover, a lower temperature could reduce the occurrence of side reactions and retain organic components in a material, which is conducive to maintaining the structure and properties of the material. This is of important scientific and practical significance for exploring the potential of gypsum pyrolysis materials in the field of phosphorus adsorption.

### BRIEF DESCRIPTION OF THE DRAWINGS

The present disclosure will be further described below with reference to the drawings.

FIG. 1 shows phosphorus adsorption isotherms of the different adsorption materials in Test Example 1 of the present disclosure.

FIG. 2 shows phosphorus adsorption isotherms of the different adsorption materials in Test Example 2 of the present disclosure.

FIG. 3 shows maximum adsorption capacities of the different adsorption materials in Test Example 3 of the present disclosure; where
a pyrolyzed gypsum board is a phosphorus adsorbent prepared by pyrolysis at 150° C. in Example 1, while an unpyrolyzed gypsum board is a product obtained by drying a waste gypsum board at 105° C. for 24 h and then crushing and sieving through a 60-mesh sieve;
a pyrolyzed desulfurized gypsum is a low-temperature pyrolysis product prepared in Comparative Example 3, while an unpyrolyzed desulfurized gypsum is a product obtained by drying desulfurized gypsum at 105° C. for 24 h and then crushing and sieving through a 60-mesh sieve;
a pyrolyzed phosphogypsum is a low-temperature pyrolysis product prepared in Comparative Example 4, while an unpyrolyzed phosphogypsum is a product obtained by drying phosphogypsum at 105° C. for 24 h and then crushing and sieving through a 60-mesh sieve;
a pyrolyzed CaSO₄·2H₂O is a low-temperature pyrolysis product prepared in Comparative Example 2, while an unpyrolyzed CaSO₄·2H₂O is a product obtained by drying a CaSO₄·2H₂O reagent at 105° C. for 24 h and then crushing and sieving through a 60-mesh sieve.

FIGS. 4A-4D show scanning electron microscopy (SEM) images of different adsorbent materials in some embodiments of the present disclosure; where

FIG. 4A shows an SEM image of the unpyrolyzed gypsum board (the product obtained by drying the waste gypsum board at 105° C. for 24 h and then crushing and sieving through the 60-mesh sieve); FIG. 4B shows an SEM image of the pyrolyzed gypsum board (Example 1, 150° C.); FIG. 4C shows an SEM image of the unpyrolyzed gypsum board (the product obtained by drying the waste gypsum board at 105° C. for 24 h and then crushing and sieving through the 60-mesh sieve) after phosphorus adsorption; and FIG. 4D shows an SEM image of the pyrolyzed gypsum board (Example 1, 150° C.) after phosphorus adsorption.

### DETAILED DESCRIPTION OF THE EMBODIMENTS

The present disclosure provides a method for preparing a phosphorus adsorbent, including:
S1, drying a waste gypsum to remove moisture;
S2, crushing and sieving an obtained dried gypsum to obtain a crushed gypsum;
S3, subjecting the crushed gypsum to low-temperature pyrolysis to obtain a pyrolysis product; and
S4, grinding and sieving the pyrolysis product to obtain the phosphorus adsorbent.

In the present disclosure, sieve specifications are not strictly limited, and a sieve of 30-100 mesh could improve a recovery efficiency of materials while ensuring uniformity of particle size.

In one embodiment, the waste gypsum is a construction waste gypsum.

In one embodiment, the drying is conducted at a temperature of 100° C. to 120° C. for 24 hours. In one embodiment, the drying is conducted at 105° C. In the present disclosure, there is no strict limitation on the temperature of the drying, but better drying effect and speed could be achieved at 105° C.

In one embodiment, the low-temperature pyrolysis is conducted in an anaerobic environment or an anoxic environment.

In one embodiment, the low-temperature pyrolysis is conducted under an inert gas atmosphere.

In one embodiment, an inert gas in the inert gas atmosphere includes but is not limited to nitrogen and argon.

In one embodiment, the inert gas has a flow rate of 0.5 L/minute to 2 L/minute.

In one embodiment, the low-temperature pyrolysis is conducted at a pyrolysis temperature of 150° C. to 300° C. for 1 hour to 4 hours, and the pyrolysis temperature is obtained by heating at a heating rate of 5° C./minute to 10° C./minute.

In one embodiment, the low-temperature pyrolysis is conducted at the pyrolysis temperature of 150° C. for 2 hours.

In the present disclosure, there is strict limitation on the heating rate in the low-temperature pyrolysis, and only the phosphorus adsorbent prepared within this range has a desirable phosphorus adsorption effect.

An increase in the pyrolysis temperature has an inhibitory effect on the phosphorus adsorption effect of a pyrolysis material of the present disclosure. Therefore, there are strict limitations on the pyrolysis temperature and heating rate to improve phosphorus adsorption performance of the material.

In the present disclosure, a gypsum board is pyrolyzed alone to enhance phosphorus adsorption capacity of the material, while multiple substances do not need to be compounded, which simplifies a material synthesis process and significantly enhances the phosphorus adsorption capacity. Experiments have shown that ability of a pyrolyzed gypsum board to adsorb phosphorus is greatly enhanced, and a maximum adsorption capacity is 6 times that of an initial gypsum board. At the same time, it is found that an optimal pyrolysis temperature of the material is 150° C. At this temperature, an original structure of the material is not significantly destroyed, reducing a risk of material denaturation. A lower temperature also avoids a risk of calcium sulfate releasing toxic gases at high temperatures. Less energy is required for the pyrolysis at 150° C., thereby reducing energy consumption and production costs. In the present disclosure, production of a phosphorus adsorbent by low-temperature pyrolysis of waste gypsum boards could effectively solve current problems of waste gypsum treatment and phosphorus pollution in water bodies and phosphorus recovery and reuse. This is a wastewater treatment technique of “waste control by waste”, which could achieve comprehensive utilization and greatly increase an economic added value of the waste gypsum boards.

The technical solutions provided by the present disclosure will be further described below with reference to the examples.

Compositions of waste gypsum boards (Shanghai Liming Resource Recycling Co., Ltd., China), desulfurized gypsum (Gongyi Yuanheng Water Purification Material Factory, China), and phosphogypsum (Gongyi Yuanheng Water Purification Material Factory, China) used in the examples, comparative examples, and test examples of the present disclosure are as follows.

| | Component (%) | | | | | | | | | |
|---|---|---|---|---|---|---|---|---|---|---|
| Sample | SO₃ | CaO | SiO₂ | Al₂O₃ | K₂O | Fe₂O₃ | P₂O₅ | TiO₂ | MgO | F |
| Phosphogypsum | 48.44 | 34.53 | 10.68 | 1.62 | 1.04 | 0.74 | 1.02 | 0.17 | 0.14 | 1.66 |
| Desulfurized | 48.00 | 42.21 | 2.92 | 1.86 | 0.15 | 3.44 | 0.03 | 0.02 | 0.71 | — |
| gypsum | | | | | | | | | | |
| Waste gypsum | 46.19 | 48.43 | 3.02 | 0.67 | 0.21 | 0.28 | 0.08 | 0.08 | 0.52 | — |
| board | | | | | | | | | | |

### Example 1

A method for preparing a phosphorus adsorbent was performed by the following steps.
S1, a waste gypsum board was dried at 105° C. for 24 hours to remove moisture.
S2, an obtained dried gypsum board was crushed and sieved through a 60-mesh sieve to obtain a crushed gypsum.
S3, the crushed gypsum was subjected to low-temperature pyrolysis to obtain a pyrolysis product;
where the low-temperature pyrolysis was conducted in a nitrogen atmosphere, where a nitrogen flow rate was 1 L/minute, a heating rate was 5° C./minute, low-temperature pyrolysis temperatures were 150° C., 200° C., 300° C., 500° C., and a low-temperature pyrolysis time was 2 hours.
S4, the pyrolysis product was ground and sieved through a 60-mesh sieve to obtain the phosphorus adsorbent.

### Example 2

S1, a waste gypsum board was dried at 105° C. for 24 hours to remove moisture.
S2, an obtained dried gypsum board was crushed and sieved through a 60-mesh sieve to obtain a crushed gypsum.
S3, the crushed gypsum was subjected to low-temperature pyrolysis to obtain a pyrolysis product;
where the low-temperature pyrolysis was conducted in a nitrogen atmosphere, where a nitrogen flow rate was 1 L/minute, a heating rate was 10° C./minute, a low-temperature pyrolysis temperature was 300° C., and a low-temperature pyrolysis time was 2 hours.
S4, the pyrolysis product was ground and sieved through a 60-mesh sieve to obtain a phosphorus adsorbent.

### Comparative Example 1

S1, a waste gypsum board was dried at 105° C. for 24 hours to remove moisture.
S2, an obtained dried gypsum board was crushed and sieved through a 60-mesh sieve to obtain a crushed gypsum.
S3, the crushed gypsum was subjected to calcination in an air atmosphere to obtain a calcined product;
where during the calcination, a heating rate was 10° C./min, a calcination temperature was 300° C., and a calcination time was 2 hours.
S4, the calcined product was ground and sieved through a 60-mesh sieve to obtain a phosphorus adsorbent.

### Comparative Example 2

S1, a CaSO₄·2H₂O reagent (Shanghai Titan Technology Co., Ltd., China) was dried at 105° C. for 24 hours to remove moisture.
S2, an obtained dried CaSO₄·2H₂O reagent was crushed and sieved through a 60-mesh sieve to obtain a crushed CaSO₄·2H₂O reagent.
S3, the crushed CaSO₄·2H₂O reagent was subjected to low-temperature pyrolysis to obtain a pyrolysis product;
where in the low-temperature pyrolysis, a heating rate was 10° C./minute, and the low-temperature pyrolysis was conducted at 300° C. for 2 hours.

### Comparative Example 3

S1, desulfurized gypsum was dried at 105° C. for 24 hours to remove moisture;
S2, an obtained dried desulfurized gypsum was crushed and sieved through a 60-mesh sieve to obtain a crushed desulfurized gypsum.
S3, the crushed desulfurized gypsum was subjected to low-temperature pyrolysis to obtain a pyrolysis product;
where in the low-temperature pyrolysis, a heating rate was 10° C./minute, and the low-temperature pyrolysis was conducted at 300° C. for 2 hours.

### Comparative Example 4

S1, phosphogypsum was dried at 105° C. for 24 hours to remove moisture.
S2, an obtained dried phosphogypsum was crushed and sieved through a 60-mesh sieve to obtain a crushed phosphogypsum.
S3, the crushed phosphogypsum was subjected to low-temperature pyrolysis to obtain a pyrolysis product;
where in the low-temperature pyrolysis, a heating rate was 10° C./minute, and the low-temperature pyrolysis was conducted at 300° C. for 2 hours.

It was found that the phosphogypsum could not adsorb phosphorus before and after pyrolysis.

### Test Example 1

The adsorbent and the pyrolysis product in Example 1 each were subjected to a phosphorus adsorption test, with an untreated waste gypsum board as a control, a specific test method was performed as follows.

For the adsorption test, a phosphorus stock solution was prepared using KH₂PO₄ and deionized water and stored at room temperature. The prepared adsorbent had a dosage of 0.1 g, a volume of the phosphorus solution was 20 mL, and a volume of a centrifuge tube for adsorption was 50 mL. Adsorption reactions were conducted at room temperature (25±3° C.) on a mechanical shaker at 200 rpm, and an adsorption contact time was 24 hours. Concentrations of the phosphorus solution were set to 10 mgP/L, 50 mgP/L, 100 mgP/L, 200 mgP/L, 400 mgP/L, 800 mgP/L, and 1,000 mgP/L. After the adsorption reactions, a supernatant was filtered with a 0.45 μm filter membrane and a phosphorus concentration of a filtrate was measured by ICP-OES.

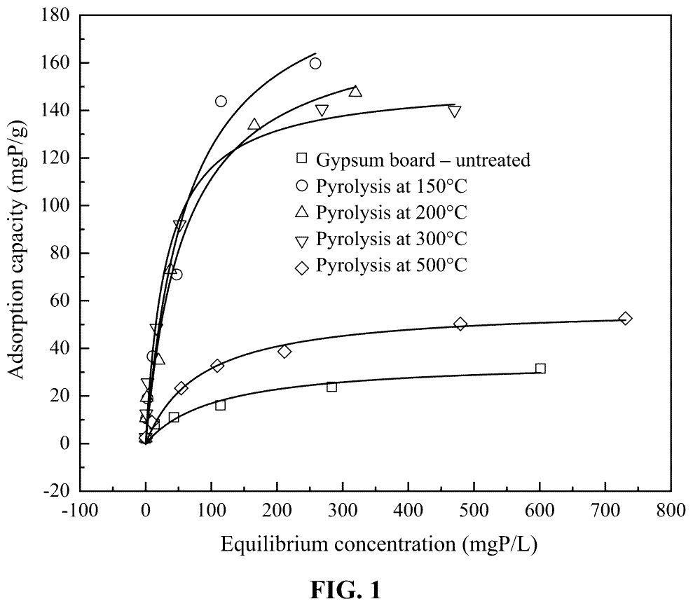

A phosphorus adsorption capacity was calculated from changes in phosphorus concentrations before and after adsorption. Each experiment was conducted in duplicate. When an experimental error was less than 3%, an average value was taken as the valid data. Test results are shown in FIG. 1.

### Test Example 2

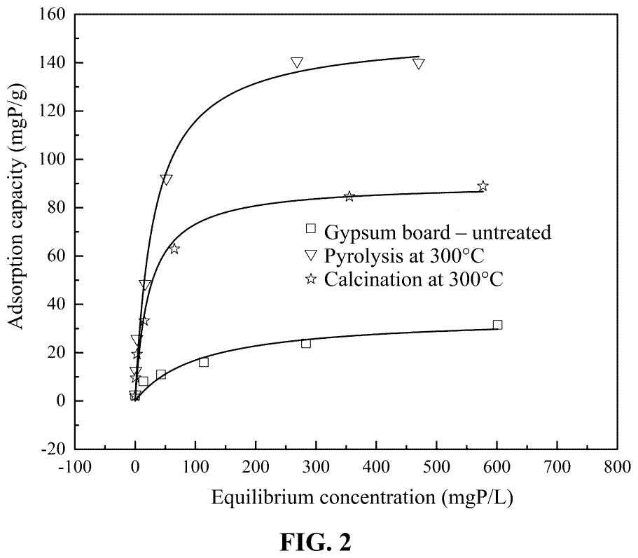

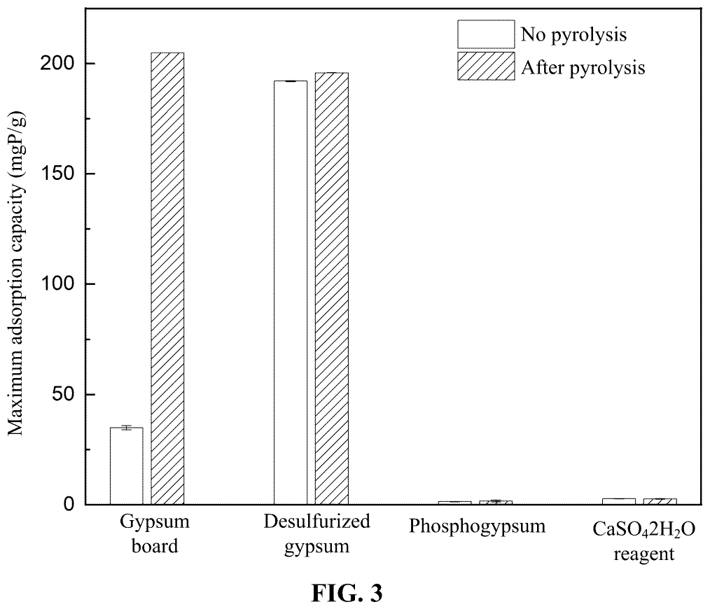

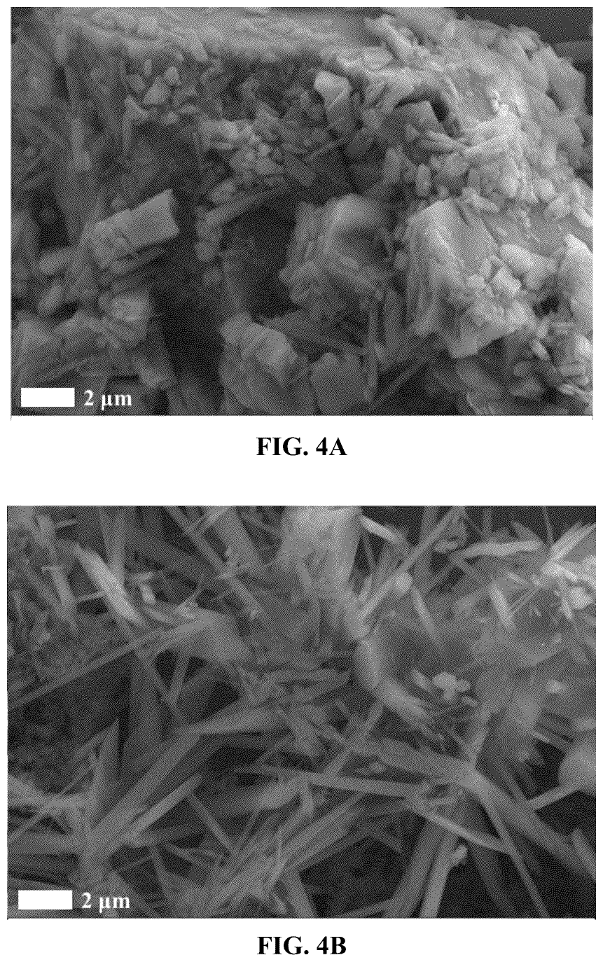

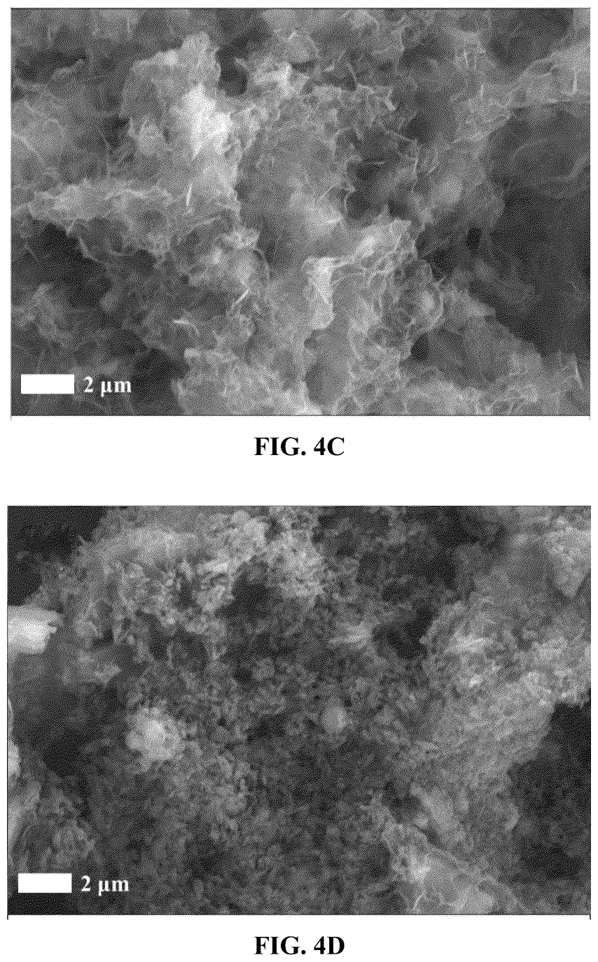

The adsorbents in Example 2 and Comparative Example 1 each were subjected to a phosphorus adsorption test, with an untreated waste gypsum board as a control. The test method was the same as that in Example 1, and test results are shown in FIG. 2.

### Test Example 3

The adsorbents in Comparative Examples 2, 3 and 4 each were subjected to a phosphorus adsorption test, with an untreated (unpyrolyzed) CaSO₄·2H₂O reagent, desulfurized gypsum, and phosphogypsum as controls. The test method was the same as that in Example 1, and test results are shown in FIG. 3.

### Example 3

This example differed from Example 1 in that: a heating rate was 3° C./minute. After testing, a maximum phosphorus adsorption capacity of the adsorption material was 87.59 mgP/g.

### Example 4

This example differed from Example 1 in that: a heating rate was 12° C./minute. After testing, a maximum phosphorus adsorption capacity of the adsorption material was 76.44 mgP/g.

Fitting adsorption isotherms with a Langmuir model show that a maximum adsorption capacity of a waste gypsum board before and after pyrolysis increased from 35.00 mgP/g to 204.85 mgP/g (FIG. 1), indicating that adsorption capacity of a pyrolysis product after low-temperature pyrolysis for phosphorus was about 6 times higher than that of an unmodified gypsum board. In addition, by comparing effects of different pyrolysis temperatures of a gypsum board on the adsorption capacity (FIG. 1), it is found that the adsorption capacity of gypsum board pyrolysis products for the phosphorus decreased with increasing pyrolysis temperature. The adsorption capacity of the gypsum board after pyrolysis and calcination at the same temperature (FIG. 2) shows that improvement in phosphorus adsorption performance of the gypsum board is affected by other factors besides removal of its own bound water. The adsorption properties of four substances, namely, the waste gypsum board, a CaSO₄·2H₂O reagent, desulfurized gypsum, and phosphogypsum, are compared before and after pyrolysis (FIG. 3). The results show that a main component of the four substances is CaSO₄·2H₂O. However, due to impurities contained in the waste gypsum board and differences in physical and chemical properties of different materials, there are different adsorption characteristics shown. That is, the waste gypsum board could effectively adsorb the phosphorus after pyrolysis, while the CaSO₄·2H₂O agent and the phosphogypsum have no significant adsorption effect on the phosphorus before and after pyrolysis. The desulfurized gypsum itself has a desirable adsorption effect on the phosphorus, but the low-temperature pyrolysis shows no synergistic effect on the desulfurized gypsum. This indicates that the gypsum board pyrolysis products in the present disclosure could adsorb the phosphorus in aqueous solution, and have desirable application prospects in the fields of phosphorus pollution in water bodies and phosphorus recovery and reuse.

Specific examples are used herein for illustration of principles and implementations of the present disclosure. The descriptions of the above embodiments are merely used for assisting in understanding the method of the present disclosure and its core ideas. In addition, those of ordinary skill in the art could make various modifications in terms of particular embodiments and the scope of application in accordance with the ideas of the present disclosure. In conclusion, the content of the description should not be construed as limitations to the present disclosure.

What is claimed is:

1. A method for preparing a phosphorus adsorbent, comprising:
S1, drying a waste gypsum to remove moisture;
S2, crushing and sieving an obtained dried gypsum to obtain a crushed gypsum;
S3, subjecting the crushed gypsum to pyrolysis in an inert gas atmosphere to obtain a pyrolysis product; and
S4, grinding and sieving the pyrolysis product to obtain the phosphorus adsorbent;
wherein based on a total weight of the waste gypsum, the waste gypsum comprises less than 47 wt % of SO₃, more than 45 wt % of CaO, and less than 1 wt % of Al₂O₃.

2. The method for preparing the phosphorus adsorbent of claim 1, wherein the waste gypsum is a construction waste gypsum.

3. The method for preparing the phosphorus adsorbent of claim 1, wherein the drying is conducted at a temperature of 100° C. to 120° C. for 24 hours.

4. The method for preparing the phosphorus adsorbent of claim 1, wherein the pyrolysis is conducted at a pyrolysis temperature of 150° C. to 300° C. for 1 hour to 4 hours, and the pyrolysis temperature is obtained by heating at a heating rate of 5° C./minute to 10° C./minute.

5. A phosphorus adsorbent prepared by the method of claim 1.

6. The phosphorus adsorbent of claim 5, wherein the waste gypsum is a construction waste gypsum.

7. The phosphorus adsorbent of claim 5, wherein the drying is conducted at a temperature of 100° C. to 120° C. for 24 hours.

8. The phosphorus adsorbent of claim 5, wherein the pyrolysis is conducted at a pyrolysis temperature of 150° C. to 300° C. for 1 hour to 4 hours, and the pyrolysis temperature is obtained by heating at a heating rate of 5° C./minute to 10° C./minute.
